(19) United States
(12) Patent Application Publication
(10) Pub. No.: US 2003/0152080 A1
(43) Pub. Date: Aug. 14, 2003

(54) System and method for fault tolerant multimedia communication

(76) Inventor: Royal O'Brien, Jacksonville, FL (US)

Correspondence Address: Mark J. Young, McGuire Woods LLP, 50 North Laura Street - Suite 3300, Jacksonville, FL, 32202, US

(21) Appl. No.: 10/365,190

(22) Filed: Feb. 12, 2003

Related U.S. Application Data
(60) Provisional application No. 60/357,018, filed on Feb. 12, 2002.

(51) Int. Cl. H04L 12/28

(52) U.S. Cl. 370/392

(57) ABSTRACT

A system and method for fault tolerant multimedia communication provides a first connectionless channel for communicating packets from a server to a client. Packets are either header packets or media packets. Header packets include only a header payload providing information pertaining to succeeding media packets. One or more media packets corresponding to a single frame of video succeeds each header packet. The client detects missing packets and determines whether or not the missing packet is a header packet. If a header packet is missing, the corresponding succeeding media packets are not processed. Instead, the system waits until the next header packet is received to resume processing of media packets succeeding that next received header packet. If a media packet is missing, the client may continue processing media packets received, although the resulting video may be somewhat distorted, especially if the received media packets depend upon the missing media packet for proper processing. Client-side buffering may be employed to detect missing packets before they are due for processing and request via a second channel, which may be connection-based or connectionless, that a server resend the missing packets if a determined amount of time remains until the missing packets are due for processing.

### PRIORITY CLAIM BASED ON PROVISIONAL APPLICATION

This application claims priority to U.S. Provisional Application 60/357,018, filed Feb. 12, 2002, the entire contents of which are hereby incorporated by reference herein.

### FIELD OF THE INVENTION

The present invention relates generally to communication systems, and in particular to a system and method for fault tolerant multimedia communication.

### BACKGROUND

A packet-switched network, such as the Internet, transports data, such as video and audio information, by dividing the data into packets of information. The packets are routed through the network and reassembled at a destination. When a packet-switched network becomes overly congested, data buffers in the network overflow. In response to buffer overflow, network devices, such as routers, may drop packets already in the buffers to store incoming packets. This results in packet loss.

Various communication protocols approach network congestion differently. For example, the connection-based Transmission Control Protocol (TCP) is an end-to-end reliable transport layer protocol that insures packets are received in the order they are sent and lost packets are retransmitted without regard to timeliness. TCP's disregard for timeliness, makes it unsuitable for real time applications, such as streaming video, which depend more heavily on timeliness of delivery than reliability. In contrast, a connectionless unreliable protocol, such as the User Datagram Protocol (UDP), does not ensure that packets reach their destination or arrive in the proper order. Thus, despite UDP's inability to guard against lost packets and packets received out of order, it is a better candidate than TCP for streaming video because it does not delay delivery of packets after a lost packet.

However, simply ignoring lost packets can result in problems such as data corruption and processing errors on the receiving end of the network. Such problems from lost packets are particularly acute in the case of streaming video, where successful processing of information in a packet may depend upon information in a lost packet.

To substantially reduce bandwidth requirements, video data (including data for audio accompanying video) are typically encoded before transmission (i.e., streaming). Compression is achieved by reducing redundancies and quantization. Widely accepted encoding standards adopted by the Motion Picture Experts Group (MPEG) include MPEG-1, MPEG-2, and MPEG-4. MPEG encoding utilizes similarities within image frames referred to as spatial or intraframe correlation, to provide intraframe compression in which the motion representations within an image frame (i.e., a portion of a video data stream or file that corresponds to a single image in a sequence of images that comprise the video) are compressed. Intraframes (I frames, a/k/a key frames) are independent of any other frames in the stream. Similarities between successive image frames, referred to as temporal or inter-frame correlation, are also used to provide inter-frame compression in which pixel-based representations of image frames are converted to motion representations. Predictive frames (P frames) are coded using motion estimation and have a dependency on the preceding I or P frame. Interpolated frames (B frames) depend upon the preceding I or P frame and the succeeding I or P frame. Thus, B and P frames depend upon other frames in a video data stream for proper processing.

Streaming video players typically utilize headers, which comprise part of the video data stream, to define parameters for one or more succeeding portions of a packet and/or succeeding packets that contain audio and/or video data. If a lost packet contains all or part of a header, a conventional video player may erroneously determine that the next packet contains the header or part thereof. This error may lead to corruption of the next frame and possibly several frames, exacerbating the lost packet problem and corrupting data that does not depend upon data in the missing packet. Thus media data depend upon preceding headers for proper processing.

Conventional client-side applications, such as streaming video players, do not adequately detect and address missing packets in a connectionless network. If a lost packet contains data corresponding to a frame upon which another frame depends, or if a frame upon which another frame depends is erroneously determined to be a missing header, a conventional video player may produce video with a noticeable degradation of quality. Simply stated, conventional systems are typically not aware if a packet containing header information has been missed so processing continues. Often this can exacerbate the missing packet problem, resulting in a series of extremely corrupted frames.

Thus, a system and method are needed for efficiently detecting and recovering from a missing packet sent via a connectionless network protocol without corrupting data that does not depend upon the missing packets.

### SUMMARY

It is an object of the present invention to provide a system and method for communicating data streams for processing by a client.

It is another object of the present invention to provide a system and method for communicating multimedia data streams that efficiently detects missing packets.

It is yet another object of the present invention to provide a system and method for communicating multimedia data streams that efficiently determines the type of payload contained within a missing packet.

It is still another object of the present invention to provide a system and method for communicating multimedia data streams that efficiently determines whether a missing packet is a header packet or not.

It is a further object of the present invention to provide a system and method for communicating multimedia data streams that may be utilized in a real time non-buffered streaming mode or in a buffered streaming mode.

It is yet a further object of the present invention to provide a system and method for communicating multimedia data streams that may be utilized in a buffered streaming mode, detects missing packets in the buffer before the missing packet is due to be processed and requests that a server resend the missing packet.

It is still a further object of the present invention to provide a system and method for communicating multimedia data streams that utilizes a connectionless transport protocol such as UDP as a primary channel for communication.

To achieve these and other objects, a system and method for fault tolerant multimedia communication are provided. In a preferred implementation the system includes a connectionless channel for communicating packets from a server to a client. Packets are preferably either header packets or media packets. Header packets include only a header payload providing information pertaining to succeeding media packets. Header packets do not include a media payload. One or more media packets corresponding to a single frame of video preferably succeeds each header packet. The client detects missing packets and determines whether or not the missing packet is a header packet. If a header packet is missing, the corresponding succeeding media packets are preferably not processed. Instead, the system waits until the next header packet is received to resume processing of media packets succeeding that next header packet. If a media packet is missing, the client will continue processing media packets received, although the resulting video may be somewhat distorted especially if the received media packets depend upon the missing media packet for proper processing. Client-side buffering may be employed to detect missing packets before they are due for processing and request via a separate channel that a server resend the missing packets if a determined amount of time remains.

### BRIEF DESCRIPTION OF THE DRAWINGS

The foregoing and other objects, features and advantages of the present invention will become better understood with reference to the following description, appended claims, and accompanying drawings, where:

FIG. 1 provides a high level network diagram that conceptually depicts an exemplary system for fault tolerant multimedia communication in accordance with the present invention;

FIG. 2 provides a high level network diagram that conceptually depicts an exemplary system for fault tolerant multimedia communication and an exemplary packetized data stream in accordance with the present invention with a lost header packet to illustrate an exemplary application;

FIG. 3 conceptually depicts data structures for information pertaining to packets in accordance with a preferred implementation of the present invention;

FIG. 4 provides a high level network diagram that conceptually depicts a system for multimedia communication and an conventional packetized data stream with a lost packet containing both a header and media payload to illustrate shortcomings of a conventional system;

FIG. 5 is a flowchart that conceptually illustrates a missing packet detection and response methodology in accordance with an exemplary implementation of the present invention;

FIG. 6 is a flowchart that conceptually illustrates a missing buffered packet detection and resend request methodology in accordance with an exemplary implementation of the present invention; and

FIG. 7 is a block diagram that conceptually illustrates buffered received packets including space for a missing packet in accordance with an exemplary implementation of the present invention.

### DETAILED DESCRIPTION

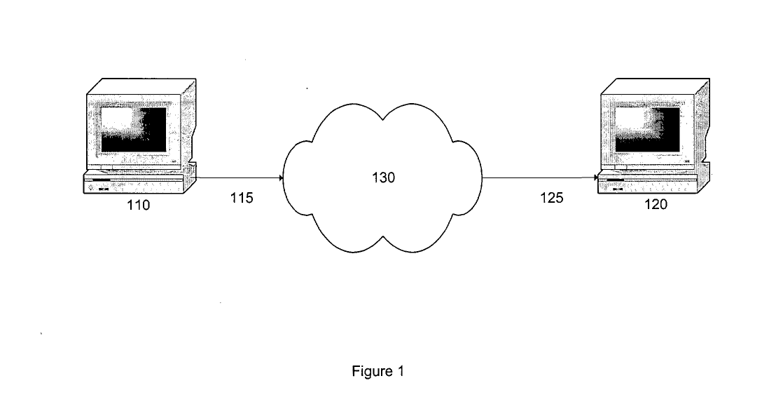

Referring to FIG. 1, an exemplary computing and network environment for implementing a system and methodology in accordance with the present invention is conceptually shown. A plurality of computing devices 110 and 120 are communicatively coupled via network communication means 115, 125 and 130. By way of example and not limitation, two computers are conceptually shown. Those skilled in the art will appreciate that other configurations with more computers may be used to implement a workflow execution and control methodology in accordance with the present invention.

Each computing device 110 and 120 may, for example, be a conventional computer with a processing unit, a system memory and a system bus that communicatively couples various system components including the system memory to the processing unit. The system bus may be any of several types of bus structures using any of a variety of bus architectures. The system memory may include read only memory (ROM) and random access memory (RAM). A basic input/output system (BIOS), containing routines that help to transfer information between elements within the computer may be stored in ROM. The computer may also include storage devices such as a magnetic hard disk drive, a magnetic disk drive for reading from or writing to removable magnetic disk, and an optical storage device such as, for example, a fiber storage loop or an optical disk drive for reading from or writing to a removable optical disk such as a CD-ROM or other optical media. The magnetic hard disk drive, magnetic disk drive, and optical disk drive may be connected to the system bus by a hard disk drive interface, a magnetic disk drive-interface, and an optical drive interface, respectively. The drives and their associated computer-readable media provide nonvolatile storage of computer readable instructions, data structures, program modules and other data for the computer. These elements are typically included in most computer systems and the aforementioned system is intended to represent a broad category of systems supporting transmission, receipt and processing of video data.

Software for implementing a system and methodology in accordance with the present invention on the above-referenced computing environment may be stored on the hard disk, magnetic disk, optical disk, ROM or RAM. The software may include an operating system, one or more application programs, other program modules, and program data. Firmware, application specific integrated circuits and other manifestations of computer processing instructions and data may be employed in lieu of or in addition to software without departing from the scope of the present invention.

A user may enter commands and information into the computer through input devices such as a keyboard and/or pointing device. Other input devices (not shown) such as a microphone, scanner or the like may be employed. These and other input devices may be connected to the processing unit through an interface coupled to system bus, such as a serial port, parallel port or universal serial bus (USB). A monitor or other type of display device may also be connected to system bus via an interface, such as video adapter. In addition to the monitor, the computer may include other peripheral output devices (not shown), such as speakers and printers.

Of course, the computer system may include fewer, different and/or additional elements, provided it is capable of performing steps in accordance with the present invention. Those skilled in the art will appreciate that the invention may be practiced with other computer system configurations, including hand-held devices, multi-processor systems, programmable equipment and machinery, minicomputers, mainframe computers, and the like. The invention may also be practiced in distributed computing environments where tasks are performed by remote processing devices that are linked through a communications network with program modules located in local and/or remote storage devices.

Each computer may operate in a networked environment using logical connections to one or more remote computers. By way of example and not limitation, the network may be a local area network (LAN) and/or a wide area network (WAN), including the Internet, a combination of the foregoing, or some other means of communicating computer readable data between remote computers. Such networking environments are commonplace.

Transmission media for the network may include optical fibers, coaxial cable, twisted copper pairs, satellite links, digital microwave radio, wireless radio links, another data transmission medium, or some combination of the foregoing. The type of network, connectivity and transmission media, along with various other factors (e.g., network congestion), largely determine how fast streamed data may be communicated from a server to a client.

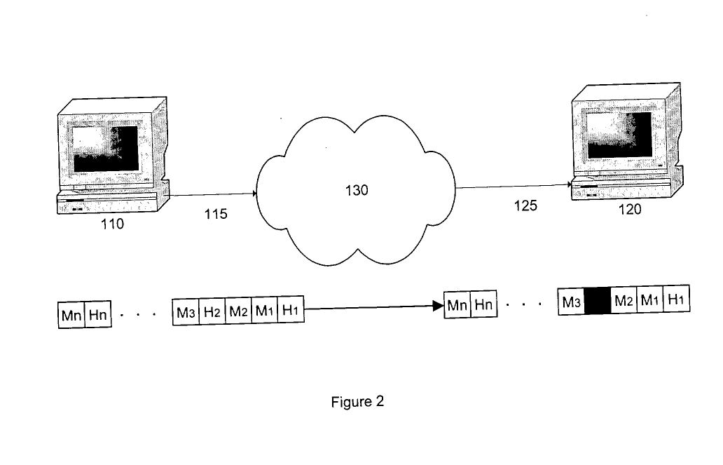

Referring now to FIG. 2, data packets are conceptually shown. In a preferred implementation, the data is transmitted from a server computer, e.g., 110, to a client computer, e.g., 120, via a connectionless network protocol, such as UDP. The client 120 preferably includes a player, i.e., a client program that receives and processes video data on the client according to an exemplary embodiment of the present invention. The player may also manage the storage and playback of streamed video data. The player may also enable VCR-type interactive functions, such as pause, rewind and fast forward. The player preferably includes means (e.g., software modules or access thereto) for performing all client functions and processes as described herein.

The data packets include packets containing header information (i.e., header packets) and packets containing media data. Header packets are conceptually shown as squares with entries Hₙ, where n equals a header number. Media packets are conceptually shown as boxes with entries Mₙ, where n equals a media packet number. A header packet provides information pertaining to the next succeeding media packet(s). A header is preferably contained in and preferably occupies one packet. Media data corresponding to a frame of video may occupy one or more than one packet. A header packet preferably precedes data corresponding to each frame of video. Thus, a media packet (or packets) containing data for a frame of video are preferably preceded by a header packet.

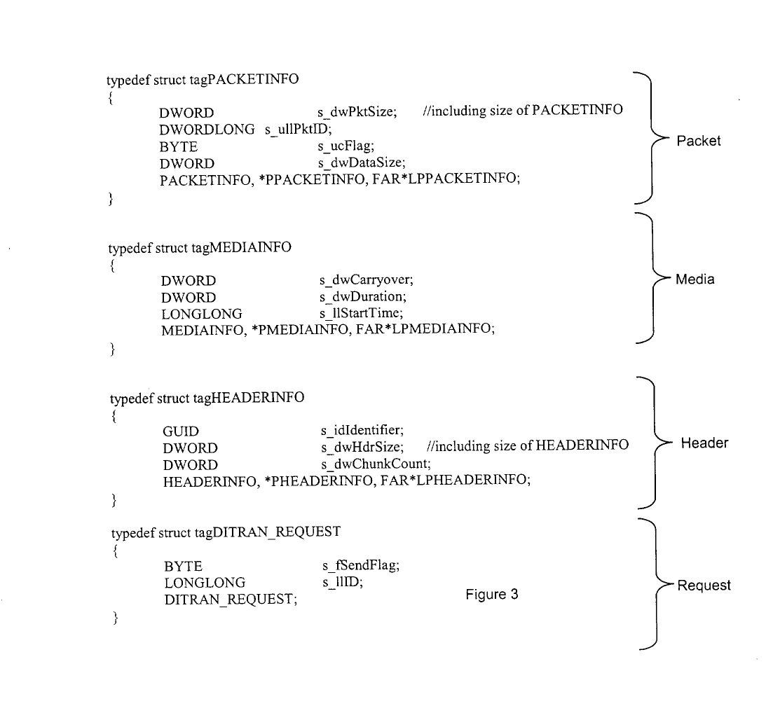

Referring now to FIG. 3, several data structures are shown, including a packetinfo structure. Each packet in the data stream preferably has a packetinfo structure defining information pertaining to the packet, such as the packet size (e.g., s_dwPktSize), a sequential id (e.g., s_ullPktlD), the type of packet (e.g., s_ucFlag) and the size of the data payload (e.g., s_dwDataSize).

In a header packet, a headerinfo structure preferably follows the packetinfo structure. Each header packet in the data stream preferably has a headerinfo structure defining information pertaining to the size of the header and type of encoding, such as a globally unique identifier (GUID) which appears in the first header to define the type of encoding (e.g., s_idldentifier), a header size (e.g., s_dwHdrSize), and the number of chunks (e.g., s_dwChunkCount), with each chunk being a range of consecutive bits in the packet.

In a media packet which may correspond to audio or video, a mediainfo structure preferably follows the packetinfo structure. Each media packet in the data stream preferably has a mediainfo structure defining information pertaining to the media payload, such as a carryover value which indicates if the payload is continued from the previous packet (e.g., s_dwCarryover), a duration for playback time for the payload (e.g., s_dwDuration), and a start time for starting playback of the payload (e.g., s_llStartTime).

A request packet is preferably communicated from the client to the server via a communication channel separate from the connectionless channel for receiving data from the server. The separate communication channel may be connection based or connectionless and may be opened for a determined or limited duration or for an entire data streaming session. Use of a connection-based protocol such as TCP helps to ensure that every packet sent by the client is received by the server.

In a request packet, preferably, a flag (e.g., s_fSendFlag) defines the action requested of the server by the client, such as to begin sending packets or to resend a missing packet. The id (s_lllD) identifies which packet to start sending.

A methodology in accordance with an exemplary implementation of the present invention may be implemented in a real time data streaming mode without client-side buffering, or in a data streaming mode with client side buffering. If implemented without buffering, the methodology detects missing packets at the client, and interrupts processing when a header is missing until the next header packet arrives.

Referring again to FIG. 2, an exemplary data stream is conceptually shown with a missing header (blackened) H2. In a preferred implementation, a determination is made whether a packet is missing from the data stream received by the client. The missing packet H₂ can be readily detected from a skip in sequential id (s_ullPktlD). Next, a determination may be made if the missing packet is a header or media packet. The media packet M₃ immediately succeeding the missing header packet H₂ can readily be determined to be a media packet from the packetinfo (s_ucFlag) and particularly one which is not a continuation from the last packet (s_dwCarryover). Thus, in the exemplary stream, the missing packet must be a header packet. If a header packet is missing, the media packets which depend upon the missing header packet are not processed and processing may resume when the next media packet is received.

On the other hand, if a media packet is missing, then dependent media packets may be processed even though processing may result in some data corruption and compromised video quality. For example, if a media packet corresponding to an I frame is missing, a subsequent packet corresponding to a P frame that depends upon that I frame may still be processed; although it will likely produce distorted video. Alternatively, processing of dependent media packets can be withheld without departing from the scope of the present invention. In other words, referring to the missing I frame packet example, the client may decide not to process the packet corresponding to the P frame, which may lead to a discontinuity in the displayed video.

Client side processing (e.g., the determinations discussed above) may be performed using a conventional processing apparatus, such as a computer system as broadly described above. Of course, the client computer processing apparatus may include fewer, different and/or additional elements than the aforementioned computer system, provided it is capable, when programmed, of performing the necessary functions in accordance with the present invention. For example, it may be comprised of a digital signal processor (DSP), an application-specific integrated circuit (ASIC), discrete gate logic, or other hardware, firmware, or any conventional programmable software module and a microprocessor in addition to or in lieu of components described above. The software module could reside in RAM memory, flash memory, registers, or any other form of readable storage medium known in the art. Additionally, the system may either stand alone or operate in a distributed environment. Moreover, by way of example and not limitation, it may take the form of a personal computer, set-top-box, electronic appliance, electronic component, a peripheral device, a personal digital assistant or some other apparatus capable of performing the desired functions.

Advantageously, packets and data structures in accordance with the present invention facilitate an efficient determination of whether or not a header packet is missing, thus enabling fault tolerant measures to be taken.

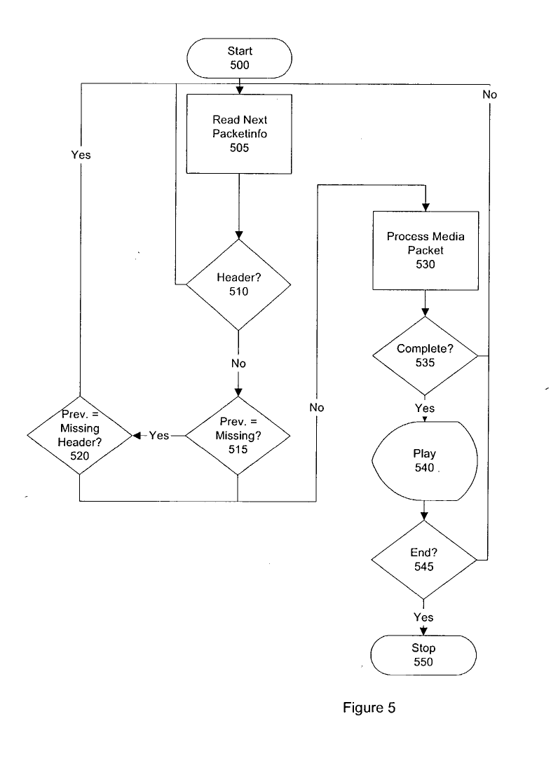

Referring now to FIG. 5, a flow chart conceptually illustrates an exemplary process in accordance with the present invention. After a packet is read 505, a determination is made whether the packet is a header 510. If it is a header, the next packet is read 505. If instead the packet is a media packet, a determination is then made whether the previous (i.e., immediately preceding) packet is missing 515, and, if so, whether the missing packet is a header packet 520. As discussed above, a missing packet can readily be detected from a skip in sequential id (s_ullPktlD), and the packetinfo for the current packet reveals the nature of the preceding packet. If the previous packet is a missing header packet, control passes back to step 505 where a new packet is read. If the previous packet is not a missing header packet, the current packet is processed 530. If the current packet comprises a complete frame or if the current packet includes the data needed to complete a frame, then the frame is played 540. Otherwise, control passes back to step 505 where a new packet is read. After a frame is played, if more packets are available, control passes back to step 505 where a new packet is read.

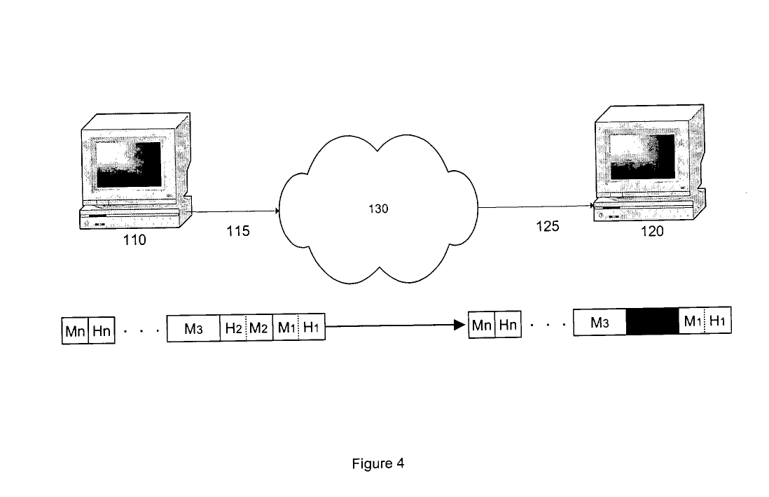

In sharp contrast, conventional systems do not place headers in separate packets. Instead, a header may be in one or more packets along with media data. Such a data stream is conceptually illustrated in FIG. 4. The first packet is comprised of a first header data H₁ and a first media data M₁. The second packet is comprised of a second media data M₂ and a second header H₂ data. In the event that the second packet is lost en route to the client, a conventional system may erroneously determine that the third media data M₃ is missing media data M₂, corrupting M₃ and all subsequent media data that depends upon M₃.

Additionally, conventional systems do not offer a means for efficiently locating the next header and restoring uncorrupted processing. The next header may be an integral part of one or more packets containing media data. Locating the next header may require scanning the packet(s), a time consuming process which is not well suited for real time processing.

In sum, conventional systems do not provide a means for efficiently determining from a current received packet whether a preceding missing packet contains header information. The present invention provides such a means for efficiently making this determination based on information in a current received packet.

By employing two channels for communication with the server, the present invention facilitates a steady stream of data over the primary connectionless channel. In the case of client side buffering, resend requests are sent to the server via a separate connectionless or connection-based channel without interfering with the video data stream.

An important advantage of the present invention is that it accommodates both processing of streaming video on demand in real time without buffering and with buffering.

Another advantage of the present invention is that it efficiently detects a missing packet, determines the type of missing packet and takes appropriate action to promptly resume or continue processing received packets. Significantly, the type of missing packet is determined from the succeeding received packet. Although, a preferred implementation of the present invention utilizes a sequential id and other information such as a carryover flag to make the determination, those skilled in the art will appreciate that other indications of a missing packet and the type of missing packet may be used without departing from the scope of the present invention. In particular, other indicators of whether a preceding missing packet contains header information (e.g., a flag having a value of 0 if the preceding packet contains header information and 1 if the preceding packet does not) may be used and are intended to come within the scope of the present invention.

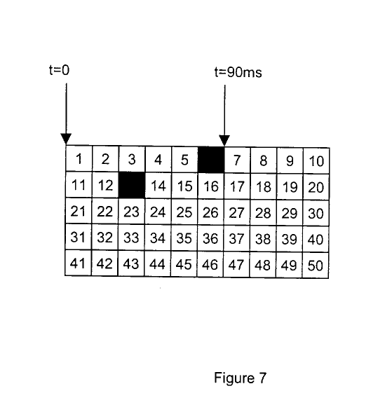

In another exemplary implementation of the present invention, client-side buffering may be employed to detect missing packets before they are due for processing. If a determined amount of time remains until the missing packets are due for processing, resend requests may be communicated to a server via a second channel, which may be connection-based or connectionless. Thus, the present invention includes a mechanism for reducing missing packet problems and enabling possible receipt of the missing packet in time for processing without interrupting the stream.

Where client side buffering is employed, both the client and server maintain a buffer of packets. The server buffer may include a determined amount of packets already sent, a packet currently being sent and packets to be sent. The client buffer preferably includes a determined amount of packets received, including a packet being processed. Such a buffer is conceptually illustrated in FIG. 7. The packets are preferably arranged in sequential order in memory. If each packet is a fixed standard size, as is preferred, then a position in memory for each packet can readily be calculated. Factors to consider in determining a suitable size include available memory, buffer size, and latency. A pointer may be used to indicate the last sequential packet id.

In a preferred implementation, the client detects missing packets a determined amount of time (e.g., approximately sixty to ninety milliseconds) before they are due for processing. Missing packets are denoted by blackened boxes in FIG. 7. Upon detection of a missing packet, a separate channel (e.g., a connection-based TCP channel) is established for communicating a resend request to the server. The separate channel preferably remains open for a determined amount of time to facilitate multiple resend requests if a plurality of packets are missing. The resend request instructs the server to send the missing packet identified by its sequential packet id. The server receives the resend request and determines if the missing packet is available (i.e., buffered on the server). If the missing packet is available at the server, it will preferably be sent via the primary connectionless channel. Upon timely receipt (i.e., receipt before the time for the packet to be processed has passed) by the client, the client performs a cyclic redundancy check (CRC) and, if the packet passes, the client places it into the intended location in the buffer. If the packet arrives after the time for it to be processed has passed, the packet will not be used. In such case, processing preferably proceeds according to the methodology described above for missing packets.

Thus, for example, 90 ms before the time to process packet 6 as shown in FIG. 7, the system detects that the packet is missing. Then, a separate channel (e.g., a connection-based TCP channel) is established for communicating a resend request to the server. The resend request instructs the server to send packet 6. The server receives the resend request and determines if packet 6 is available (i.e., buffered on the server). If packet 6 is available at the server, it will preferably be sent via the primary connectionless channel. If packet 6 is received by the client before the time for it to be processed, the client performs a cyclic redundancy check (CRC) and, if the packet passes, the client places it into the intended location in the buffer. If packet 6 arrives after the time for it to be processed has passed, the packet will not be used. If the separate channel for the resend request is closed by the time packet 13 is detected as missing, a separate channel will be established again.

Advantageously, the connection-based channel will not hamper or stop the connectionless channel. Thus, packets can continue to be sent and received while the resend request is transmitted and processed.

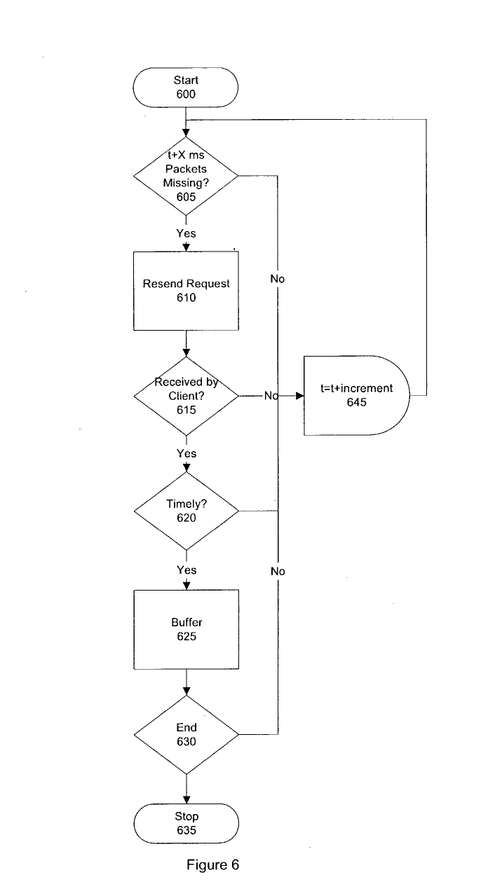

Referring now to FIG. 6, a flowchart is provided that conceptually illustrates a resend request methodology in accordance with the present invention. The client detects if a packet is missing a determined amount of time (e.g., approximately sixty to ninety milliseconds) before the packet is due for processing as in step 605. Assuming, for example, each pair of media packets represents approximately 30 ms of playback time, then 90 ms includes approximately six packets. Of course, if a packet is not missing, a resend request is not necessary. In such case, as time increments 645, the client detects if a next packet is missing, and so on. Upon detection of a missing packet, a separate channel (e.g., a connection-based TCP channel) is established for communicating a resend request to the server 610. As discussed above, the separate channel preferably remains open for a determined amount of time to facilitate multiple resend requests if a plurality of packets are missing. The resend request instructs the server to send the missing packet identified by its sequential packet id. The server receives the resend request and determines if the missing packet is available (i.e., buffered on the server). If the missing packet is available at the server, it will preferably be sent via the primary connectionless channel, although it may be sent by the separate connection-based channel if it is open. Upon timely receipt (i.e., receipt before the time for the packet to be processed has passed) by the client 615-620, the client checks the packet's CRC and, if the packets CRC passes, the client places the packet into its intended location in the buffer 625. If the packet arrives after the time for it to be processed has passed, the packet will not be buffered and will not be used. In such case, processing preferably proceeds according to the methodology described above for missing packets. Additionally, the client may pause processing the buffered data and wait to resume processing until the contiguous buffered data at least equals a determined threshold. The threshold amount may be a preset amount or an amount determined based on network conditions and/or the bit rate of encoded video.

The system and methodology described above use streaming video data as an example. Those skilled in the art will appreciate that the streamed data may be any streaming media, including audio data.

While the invention has been described in terms of its preferred embodiments, those skilled in the art will recognize that the invention can be practiced with modifications within the spirit and scope of the foregoing detailed description. Such alternative embodiments and implementations are intended to come within the scope of the present invention.

Having thus described the invention, what I claim as new and desire to secure by Letters Patent is as follows:

1. A system for fault tolerant multimedia communication comprising a connectionless channel, a data stream for communication over the connectionless channel, said data stream comprised of a plurality of packets, said packets being comprised of header information and media information, means for determining if a packet comprised of header information is missing based on information contained in a packet succeeding the header information.

2. A system according to claim 1 wherein said data stream is comprised of a plurality of header packets and media packets, with one or more media packets corresponding to a single multimedia frame immediately succeeding each header packet, and said system is further comprised of means for halting processing of media packets if a header packet is missing until a next header packet is received.

3. A system according to claim 2, further comprising means for buffering received packets and means for requesting that missing packets be resent before a time for processing the missing packet arrives.
